(19) United States
(12) Patent Application Publication
(10) Pub. No.: US 2026/0336041 A1
(43) Pub. Date: Oct. 29, 2026

(54) SURFACE TREATMENT FLUID, COPPER SURFACE TREATMENT METHOD, COPPER-TIN JOINING METHOD, AND JOINED BODY PRODUCTION METHOD

(71) Applicant: MEC COMPANY LTD., Hyogo (JP)

(72) Inventors: Ryo NEGISHI, Hyogo (JP); Satoshi SAITO, Hyogo (JP); Itsuro TOMATSU, Hyogo (JP)

(73) Assignee: MEC COMPANY LTD., Hyogo (JP)

(21) Appl. No.: 18/993,252

(22) PCT Filed: Jun. 22, 2023
(86) PCT No.: PCT/JP2023/023148

§ 371 Date: Jan. 10, 2025

(30) Foreign Application Priority Data
Jul. 13, 2022 (JP) 2022-112430

(51) Int. Cl. B23K 35/36; B23K 20/02; B23K 103/18

(52) U.S. Cl. CPC B23K 35/3613; B23K 20/023; B23K 2103/18

(57) ABSTRACT

A surface treatment liquid is an aqueous solution containing: a water-soluble copper salt; a thio compound having a structure in which one or more nitrogen atoms and one or more sulfur atoms are covalently bonded to one carbon atom; and one or more nitrogen-containing basic compounds selected from basic amino acids, guanidine compounds, and quaternary ammonium salts. In the surface treatment liquid, the water-soluble copper salt concentration is preferably 0.05 to 70 mM and the thio compound concentration is preferably 0.005 to 20 mM. Bringing the surface treatment liquid into contact with a copper surface makes it possible to improve the joining performance to tin.

### TECHNICAL FIELD

The present invention relates to a copper surface treatment liquid, a copper surface treatment method, a copper-tin joining method, and a joined body production method.

### BACKGROUND ART

In a semiconductor or a printed wiring board, a surface of copper as a conductor is joined to another substrate, an electronic component, an insulator, or the like. Several methods have been proposed for improving the joining strength by surface treatment of copper when another member is joined to copper surface.

For example, Patent Document 1 discloses that adhesion to a resin layer is improved by forming a copper-tin alloy layer on a copper surface. Patent Document 2 discloses treating copper surface with a solution containing copper ions and a silane coupling agent to form a film, thereby improving adhesion to a resin layer.

In flip chip bonding, mounting may be performed by joining a copper bump of a substrate and a tin electrode of a chip by thermocompression bonding. At that time, by forming a tin plating layer or a nickel/gold plating layer on the surface of the copper bump, joining performance to the tin electrode is improved. In addition, the joining performance may be further improved by surface treatment such as application of a flux (see, for example, Patent Document 3).

### PRIOR ART DOCUMENTS

### Patent Documents

Patent Document 1: JP 2008-109111 A
Patent Document 2: JP 2022-020415 A
Patent Document 3: JP 2021-190473 A

### SUMMARY OF THE INVENTION

### Problems to be Solved by the Invention

An object of the present invention is to provide a copper surface treatment liquid for more easily joining copper and tin.

### Means for Solving the Problems

The surface treatment liquid of the present invention is an aqueous solution containing: a water-soluble copper salt; a thio compound having a structure containing one or more nitrogen atoms and one or more sulfur atoms covalently bonded to one carbon atom; and one or more nitrogen-containing basic compounds selected from basic amino acids, guanidine compounds, and quaternary ammonium salts. The concentration of the water-soluble copper salt in the surface treatment liquid is preferably 0.05 to 70 mM, and the concentration of the thio compound is preferably 0.005 to 20 mM.

Surface treatment of copper is performed by bringing the above solution into contact with a copper surface. Copper and tin are joined by thermocompression-bonding a tin member to the treated surface.

### Effects of the Invention

By surface-treating copper or a copper alloy using the surface treatment liquid of the present invention, joining performance to tin can be improved.

### MODE FOR CARRYING OUT THE INVENTION

### [Surface Treatment Liquid]

A surface treatment liquid of the present invention is used for improving a joining performance of tin to a copper surface. The surface treatment liquid is an aqueous solution containing a water-soluble copper salt, a thio compound having a specific structure, and one or more nitrogen-containing organic compounds selected from basic amino acids, guanidine compounds, and quaternary ammonium salts.

### <Water-Soluble Copper Salt>

The water-soluble copper salt releases cupric ions when dissolved in water. Examples of the water-soluble copper salt include copper sulfate, copper nitrate, copper chloride, copper acetate, copper sulfide, copper cyanide, ammonium copper chloride, copper gluconate, copper tartrate, copper perchlorate, and hydrates thereof. Copper sulfate, copper nitrate, copper chloride, and copper acetate are preferable from the viewpoint of handleability, cost, raw material availability, and the like.

### <Thio Compound>

The surface treatment liquid contains a thio compound having a structure in which one or more nitrogen atoms and one or more sulfur atoms are covalently bonded to one carbon atom.

In the structure in which one or more nitrogen atoms and one or more sulfur atoms are covalently bonded to one carbon atom, an element (hydrogen, carbon, oxygen, or the like) other than nitrogen and sulfur may be bonded to the same atom, and only the one or more nitrogen atoms and the one or more sulfur atoms may be bonded to the one carbon atom.

From the viewpoint of forming a copper surface excellent in joining performance to tin, the thio compound preferably has a structure in which only nitrogen atom(s) and sulfur atom(s) are covalently bonded to one carbon atom. Examples of the structure in which only nitrogen atom(s) and sulfur atom(s) are covalently bonded to one carbon atom include a structure in which one nitrogen atom and one sulfur atom are bonded to one carbon atom as in Formulas (A) and (B) below, a structure in which two nitrogen atoms and one sulfur atom are bonded to one carbon atom as in Formulas (C) and (D) below, and a structure in which one nitrogen atom and two sulfur atoms are bonded to one carbon atom as in Formulas (E) and (F) below.

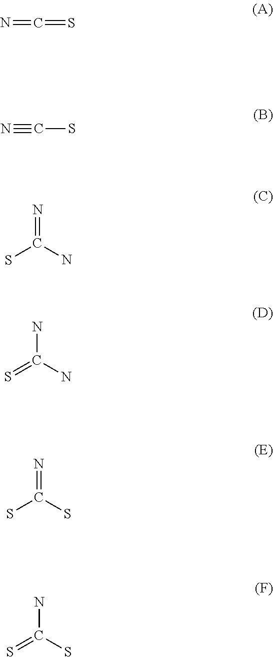

Examples of the thio compound having the structure of Formula (A) above include isothiocyanate esters such as methyl isothiocyanate, ethyl isothiocyanate, propyl isothiocyanate, isopropyl isothiocyanate, butyl isothiocyanate, isobutyl isothiocyanate, cyclohexyl isothiocyanate, allyl isothiocyanate, 3-buten-1-yl isothiocyanate, ethoxycarbonyl isothiocyanate, 2-chloroethyl isothiocyanate, 3-(methylthio)propyl isothiocyanate, 1-adamantyl isothiocyanate, phenyl isothiocyanate, benzyl isothiocyanate, benzoyl isothiocyanate, 3-pyridyl isothiocyanate, 1-naphthyl isothiocyanate, and 1,4-phenylene diisothiocyanate.

Examples of the thio compound having the structure of Formula (B) above include thiocyanate salts such as sodium thiocyanate, potassium thiocyanate, ammonium thiocyanate, lithium thiocyanate, and copper thiocyanate; and thiocyanate esters such as methyl thiocyanate, ethyl thiocyanate, benzyl thiocyanate, and guanidine thiocyanate.

Examples of the thio compound having the structure of Formula (C) above include isothiourea; isothiourea derivatives such as S-ethylisothiourea, 2-(cyanomethyl)isothiourea, S-(benzylthio)isothiourea, and S-ethylisothiourea hydrobromide and salts thereof; and thiourea dioxide.

The thio compound having the structure of Formula (C) above may be a compound in which a —N—C═N— moiety, a —N—C—S— moiety, or a —N═C—S— moiety forms a ring structure. Specific examples of the compound having the structure of Formula (C) above in which the —N—C═N— moiety forms a ring structure include 2-mercapto-1H-imidazole, 2-mercapto-1-methylimidazole, and 2-mercaptobenzimidazole and derivatives thereof, 2-mercaptopyrimidine and derivatives thereof, trithiocyanuric acid and salts thereof, 2-thiobarbituric acid, 3-amino-5-mercapto-1,2,4-triazole, 5-mercapto-1-methyltetrazole, 5-mercapto-1-phenyltetrazole, and 6-amino-2-thioxo-1,2-dihydropyrimidin-4 (3H)-one.

Examples of the thio compound having the structure of Formula (D) above include thiourea; and thiourea derivatives such as 1-methylthiourea, 1,3-dimethylthiourea, 1,3-diethylthiourea, 1,3-dipropylethylthiourea, 1,3-diisopropylthiourea, 1,3-dibutylthiourea, guanylthiourea, 1,3-diphenylthiourea, tetramethylthiourea, ethylenethiourea, 1-phenylthiourea, 1,3-dicyclohexylthiourea, 1-allylthiourea, thiosemicarbazide, and thioacetazone.

The thio compound having the structure of Formula (D) above may be a compound in which a —N—C—N— moiety or a —N—C═S— moiety forms a ring structure. Specific examples of the compound in which the —N—C—N— moiety forms a ring structure include 2-thiouracil and derivatives thereof, and 2,6-dimercaptopurine. In addition, due to tautomerism, the compound having the structure of Formula (C) above in which of the —N—C═N— moiety has a ring structure may be the compound having the structure of Formula (D) above in which in the —N—C—N— moiety has a ring structure.

Examples of the thio compound having the structure of Formula (E) above include S,S′-dimethyl N-cyanodithioiminocarbonate, potassium monomethyl cyanimidodithiocarbonate, and N-[bis(methylthio)methylene]-p-toluenesulfonamide.

In the thio compound having the structure of Formula (E) above, a —N═C—S— moiety or a —S—C—S— moiety may form a ring structure. Specific examples of the compound in which the —N═C—S— moiety forms a ring structure include bismuthiol, 2-mercaptothiazoline, thiazole-2-thiol, 2-mercaptobenzothiazole, 2-(methylthio)-2-thiazoline, 5-methyl-1,3,4-thiadiazole-2-thiol, 2-amino-5-mercapto-1,3,4-thiadiazole, and 2-mercapto-5-methylthio-1,3,4-thiadiazole.

Examples of the thio compound having the structure of Formula (F) above include dimethyldithiocarbamate salts; dietbyldithiocarbamate salts; dimethyldithiocarbamate esters such as methyl dimethyldithiocarbamate and benzyl dimethyldithiocarbamate; diethyldithiocarbamate esters such as methyl diethyldithiocarbamate and benzyl diethyldithiocarbamate; thiuram-based compounds such as tetramethylthiuram monosulfide, tetramethylthiuram disulfide, tetraethylthiuram disulfide, tetrabutylthiuram disulfide, tetraisopropylthiuram disulfide, tetrabenzylthiuram disulfide, and dipentamethylenethiuram tetrasulfide; S—(N,N-dimethylthiocarbamoyl)thioglycolic acid, ammonium 1-pyrrolidinecarbodithioate, cyanomethyl methyl(phenyl)carbamodithioate, allyl 1-pyrrolidinecarbodithioate, and p-xylylenebis(N,N-diethyldithiocarbamate).

In the thio compound having the structure of Formula (F) above, a —N—C—S— moiety, a —N—C═S— moiety, or a —S—C═S— moiety may form a ring structure. Specific examples of the compound in which the —N—C—S moiety forms a ring structure include rhodanine and derivatives thereof, 1,3-thiazinane-2-thione, and 2-thioxo-3-aminothiazolidin-4-one.

Among Formulas (A) to (F) above, Formulas (A) to (D) in which one sulfur atom is bonded to a carbon atom are particularly preferable.

### <Nitrogen-Containing Basic Compound>

The surface treatment liquid contains a nitrogen-containing basic compound in addition to the water-soluble copper salt and the thio compound. Examples of the nitrogen-containing basic compound include basic amino acids, guanidine compounds, and quaternary ammonium salts.

### (Basic Amino Acid)

The basic amino acid is an amino acid having an isoelectric point of more than 7, and specific examples thereof include arginine, histidine, lysine, citrulline, omithine, and hydroxylysine.

### (Guanidine Compound)

The guanidine compound is a compound having a guanidino group, and specific examples thereof include guanidine salts such as guanidine carbonate, guanidine phosphate, guanidine hydrochloride, guanidine hydrobromide, guanidine hydroiodide, guanidine nitrate, guanidine sulfate, guanidine sulfamate, and guanidine thiocyanate; guanylurea salts such as guanylurea carbonate, guanylurea phosphate, guanylurea hydrochloride, guanylurea nitrate, and guanylurea sulfate; aminoguanidine salts such as aminoguanidine bicarbonate, aminoguanidine nitrate, aminoguanidine hydrochloride, and aminoguanidine hemisulfate; salts of guanidine derivatives such as 1-methylguanidine sulfate, 1,1-dimethylguanidine sulfate, 1,1-diethylguanidine sulfate, 1,3-diphenylguanidine sulfate, 1-octadecylguanidine hydrochloride, and 1-(2-methyl-5-nitrophenyl)guanidine nitrate; salts of aminoguanidine derivatives such as 1,3-diaminoguanidine hydrochloride and 1-(5-nitrofurfurylidene)aminoguanidine hydrochloride; 1,1,3,3-tetramethylguanidine, 2-tert-butyl-1,1,3,3-tetramethylguanidine, phenylguanidine, 1,3-diphenylguanidine, 1,2,3-triphenylguanidine, nitroguanidine, 1-acetylguanidine, acetylacetoneguanidine, 1-(tert-butoxycarbonyl)guanidine, 1,3-bis(tert-butoxycarbonyl)-2-(trifluoromethanesulfonyl)guanidine, 1,2,3-tris(tert-butoxycarbonyl)guanidine, creatine, cyanoguanidine, sulfaguanidine, nitrosoguanidine, cimetidine, dinotefuran, 1-methyl-3-nitro-1-nitrosoguanidine, 1,3-di-o-tolylguanidine, 1-methyl-3-nitroguanidine, and 1-(4-cyanophenyl)guanidine.

### (Quaternary Ammonium Salt)

Examples of the quaternary ammonium salt include tetraalkylammonium salts such as tetramethylammonium salts, tetraethylammonium salts, ethyltrimethylammonium salts, and N,N,N-trimethyl-1-adamantylammonium salts; trialkylmonoarylammonium salts such as trimethylphenylammonium salts and benzyltrimethylammonium salts; dialkylpiperidinium salts such as 1,1-dimethylpiperidinium salts, 1-ethyl-1-methylpiperidinium salts, 1-methyl-1-propylpiperidinium salts, and 1-butyl-1-methylpiperidinium salts; dialkylpyrrolidinium salts such as 1,1-dimethylpyrrolidinium salts, 1-ethyl-1-methylpyrrolidinium salts, 1-methyl-1-propylpyrrolidinium salts, and 1-butyl-1-methylpyrrolidinium salts; choline derivatives such as choline, choline chloride, and acetylcholine chloride; anhydrous betaine, betaine hydrochloride, and carnitine.

Counter anions of the quaternary ammonium salt include Cl⁻, Br⁻, I⁻, ClO₄⁻, BF₄⁻, CH₃COO⁻, PF₆⁻, HSO₄⁻, and C₂H₅SO₄.

The quaternary ammonium salt may be a compound having a polymerizable functional group such as methacryloylcholine chloride, glycidyltrimethylammonium chloride, trimethylvinylammonium chloride, trimethylaminoethyl methacrylate methylsulfate, diallyldimethylammonium chloride, and diallylmethylethylammonium ethylsulfate.

The quaternary ammonium salt may be a polymer (quaternary ammonium salt polymer) having a quaternary ammonium group. The weight-average molecular weight of the quaternary ammonium salt polymer is preferably 1,000 or more, and may be 2,000 or more or 3,000 or more. From the viewpoint of water solubility, the weight-average molecular weight of the quaternary ammonium salt polymer is preferably five million or less, more preferably two million or less.

Examples of the quaternary ammonium salt polymer include a polymer of the above-described quaternary ammonium salt having a polymerizable functional group. Specific examples of the quaternary ammonium salt polymer include a polymer having a repeating unit represented by Formula (I) below.

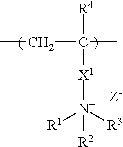

In Formula (I), R¹ to R³ are each independently a chain or cyclic hydrocarbon group optionally having a substituent, and two or more of R¹ to R³ may be bonded to each other to form a cyclic structure. R⁴ is a hydrogen atom or a methyl group, X¹ is a single bond or a divalent linking group, and Z⁻ is a counter anion.

Specific examples of the polymer having a repeating unit represented by Formula (I) include a quaternary ammonium salt styrene polymer and a quaternary ammonium salt aminoalkyl (meth)acrylate polymer.

The quaternary ammonium salt polymer may have a repeating unit in which a carbon atom of a main chain and a quaternary ammonium group form a cyclic structure as represented by Formula (II) below.

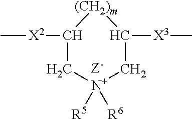

In Formula (II) above, R⁵ and R⁶ are each a chain or cyclic hydrocarbon group optionally having a substituent, and R⁵ and R⁶ may be bonded to each other to form a cyclic structure. m is an integer of 0 to 2. X² and X³ are each independently a single bond or a divalent linking group. Specific examples of the polymer having a repeating unit represented by Formula (II) include a quaternary ammonium salt diallylamine polymer obtained by polymerization of a diallyldialkylammonium salt represented by Formula (IIa).

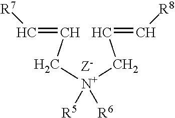

In Formula (IIa), R′ and R⁸ are each independently a hydrogen atom or a chain or cyclic hydrocarbon group optionally having a substituent, preferably a hydrogen atom.

When X¹ to X³ are divalent linking groups, specific examples thereof include a methylene group, an alkylene group having 2 to 10 carbon atoms, an arylene group, a —CONH—R— group, and a —COO—R— group (where R is a single bond, a methylene group, an alkylene group having 2 to 10 carbon atoms, or an ether group (alkyloxyalkyl group) having 2 to 10 carbon atoms).

The quaternary ammonium salt polymer may be a copolymer. The quaternary ammonium salt polymer may be a copolymer of a monomer containing a quaternary ammonium group and a monomer not containing a quaternary ammonium group. The arrangement of the repeating units in the copolymer is not particularly limited, and may be any of an alternating copolymer, a block copolymer, and a random copolymer. When the copolymer is a block copolymer or a random copolymer, the ratio of the repeating unit containing a quaternary ammonium group to the monomer units of the whole polymer is preferably 20 mol % or more, more preferably 30 mol % or more, still more preferably 40 mol % or more. Examples of the repeating unit not containing a quaternary ammonium group include structures derived from (meth)acrylic acid, alkyl (meth)acrylate, aminoalkyl (meth)acrylate, (meth)acrylamide, styrene derivatives, and sulfur dioxide.

### <Composition of Surface Treatment Liquid>

The surface treatment liquid is prepared by dissolving each of the above components in water. As the water, water from which ionic substances and impurities have been removed is preferable, and for example, ion-exchanged water, pure water, ultrapure water, or the like is preferably used. As the solvent, a mixed solvent of water and an organic solvent miscible with water, such as ethanol and isopropyl alcohol, may be used.

The surface treatment liquid may contain components other than those described above. Examples of other components include complexing agents, surfactants, stabilizers, and silane coupling agents.

The concentration of the water-soluble copper salt in the surface treatment liquid is preferably 0.05 mM or more. When the concentration of the water-soluble copper salt (cupric ions in the solution) is 0.05 mM or more, the surface treatment efficiency of copper is enhanced, and a surface having high joining performance to tin is formed. The concentration of the water-soluble copper salt is more preferably 0.1 mM or more, and may be 0.3 mM or more, 0.5 mM or more, or 1 mM or more.

On the other hand, when the concentration of the water-soluble copper salt is excessively high, since the joining performance to tin is not sufficiently improved, the concentration of the water-soluble copper salt in the surface treatment liquid is preferably 70 mM or less, more preferably 50 mM or less, still more preferably 40 mM or less, and may be 30 mM or less or 20 mM or less. When the concentration of the water-soluble copper salt is high, the etching rate of copper by cupric ions in the solution is high, and the formation of a film is inhibited, so that it is considered that the joining performance to tin is not sufficiently improved.

The concentration of the thio compound in the surface treatment liquid is preferably 0.005 mM or more, and may be 0.01 mM or more or 0.02 mM or more. It is considered that when the thio compound having a structure in which nitrogen atom(s) and sulfur atom(s) are covalently bonded to one carbon atom coexists with cupric ions, the thio compound acts as a chelating agent for copper, and a film is formed on the copper surface.

Even when the copper surface is treated with a solution not containing the thio compound, the joining performance to tin is hardly improved. In contrast, by treating the copper surface with a solution containing a trace amount of the thio compound in addition to the water-soluble copper salt, the joining performance to tin is greatly improved. On the other hand, when the concentration of the thio compound is excessively high, the joining performance to tin is not sufficiently improved. Therefore, the concentration of the thio compound in the surface treatment liquid is preferably 20 mM or less, more preferably 10 mM or less, still more preferably 5 mM or less, and may be 3 mM or less, 2 mM or less, or 1 mM or less.

The molar concentration of the water-soluble copper salt is preferably 0.05 to 500 times, and may be 0.1 to 300 times, 0.5 to 200 times, or 1 to 150 times the molar concentration of the thio compound from the viewpoint of promoting the surface treatment of copper (formation of a film on the surface) and improving the joining performance to tin.

The concentration of the nitrogen-containing basic compound in the surface treatment liquid is, although not limited to, preferably 0.01 g/L or more, and may be 0.05 g/L or more, 0.1 g/L or more, 0.5 g/L or more, or 1 g/L or more from the viewpoint of surface treatment efficiency. From the viewpoint of water solubility of the compound and the like, the concentration of the nitrogen-containing basic compound is preferably 50 g/L or less, more preferably 30 g/L or less, and may be 20 g/L or less or 10 g/L or less.

Even when the copper surface is treated with a solution containing the water-soluble copper salt and the thio compound but not containing the nitrogen-containing basic compound, the joining performance to tin is improved, but the effect thereof is limited. By treating the copper surface with a solution containing the nitrogen-containing basic compound in addition to the water-soluble copper salt and the thio compound, the joining performance to tin is dramatically improved. It is considered that the nitrogen-containing basic compound acts as a stabilizer, maintains the concentration of each component in the vicinity of the copper surface, and has an action of promoting the surface treatment.

Although the pH of the surface treatment liquid is not particularly limited, from the viewpoint of suppressing insolubilization of the copper salt and increasing the surface treatment efficiency, the pH of the surface treatment liquid is preferably 10 or less, and may be 9 or less, 8 or less, or 7 or less. From the viewpoint of solution stability and handleability, the pH of the surface treatment liquid is preferably 0 or more, and may be 1 or more or 2 or more. In order to adjust the pH of the solution, a pH controller (acid or alkali) may be added to the surface treatment liquid.

### [Surface Treatment of Copper and Formation of Copper-Tin Joined Body]

Surface treatment of copper is performed by bringing the above solution into contact with a copper surface and drying and removing the solvent. The copper may be pure copper or a copper alloy. Examples of the copper member include a copper foil (electrolytic copper foil and rolled copper foil), copper plating (electroless copper plating and electrolytic copper plating), and a copper steel material. Examples of the component including the copper member include a semiconductor substrate, an electronic substrate such as a printed wiring board, and a lead frame.

If necessary, the copper surface is washed with an acid or the like, and then the above solution is brought into contact with the copper surface to perform surface treatment of copper. Examples of the method for bringing the solution into contact with the copper surface include an immersion method, a spray method, and a bar coating method.

A state where the solution is in contact with the copper surface is maintained for about two seconds to five minutes. The temperature of the solution at this time is preferably about 10 to 50° C., more preferably about 15 to 35° C. In the immersion treatment, rocking may be performed as necessary. If necessary, washing with pure water or the like followed by drying is performed.

By thermocompression-bonding the tin member to the copper member after the surface treatment, copper and tin are joined to form a copper-tin joined body. Tin may be pure tin or a tin alloy such as solder. The tin member joined to the copper surface is typically a plating layer of tin or a tin alloy, and the tin plating layer may be partially formed at a joint portion to copper of a connection terminal.

When heating and pressurization are performed in a state where the surface-treated copper and the tin plating layer are in contact with each other, an alloy layer is formed at the interface, and copper and tin are joined to each other. The heating temperature is, although not particularly limited to, preferably 150° C. or higher, more preferably 200° C. or higher, particularly preferably the melting point (232° C.) of tin or higher, from the viewpoint of promoting the formation of the alloy layer at the interface. In the case of a tin alloy having a low melting point, heating may be performed at a temperature lower than the melting point of tin. The upper limit of the heating temperature is, although not limited to, generally 500° C. or lower, and may be 400° C. or lower, 350° C. or lower, or 300° C. or lower.

In general, in the case of joining copper and tin, a method of forming a tin plating layer on a copper surface to join tin to tin, or a method of applying a flux to a copper surface or a tin surface to promote the formation of a copper-tin alloy is adopted. By treating the copper surface with the above solution, the formation of the copper-tin alloy by thermocompression bonding is promoted without performing these treatments, so that copper and tin can be firmly joined.

### EXAMPLES

Hereinafter, the present invention will be described in more detail on the basis of examples and comparative examples, but the present invention is not to be construed as being limited to the following examples.

### [Preparation of Solution]

Aqueous solutions were prepared by dissolving the components shown in Table 1 in ion-exchanged water so as to have predetermined blending amounts (concentrations). Details of polymers 1 to 4 in Table 1 are as follows.

### <Polymer 1>

A four-necked flask equipped with a stirring blade, a thermometer, and a reflux condenser was charged with 100 parts by weight of ion-exchanged water and 20 parts by weight of isopropyl alcohol as solvents, 100 parts by weight of 60% triallylethylammonium ethylsulfate as a monomer, and 1.5 parts by weight of 2,2-azobis [N-(2-carboxyethyl)-2-methylpropionamidine] dihydrate as a polymerization initiator were added, and the temperature was raised to about 70° C. over 20 minutes. After heating at 70° C. for 2 hours, 30 parts by weight of ion-exchanged water and 1.5 parts by weight of the polymerization initiator were added, and the mixture was further heated at 70° C. for 3 hours. Isopropyl alcohol was distilled off under reduced pressure. After the mixture was allowed to cool, ion-exchanged water was added to provide a 30-wt % solution of the polymer 1.

### <Polymer 2>

A four-necked flask equipped with a stirring blade, a thermometer, and a reflux condenser was charged with 100 parts by weight of ion-exchanged water and 20 parts by weight of isopropyl alcohol as solvents, 100 parts by weight of 60% diallyldimethylammonium chloride as a monomer, and 4.5 parts by weight of diammonium peroxodisulfate as a polymerization initiator were added, and the temperature was raised to about 70° C. over 20 minutes. After heating at 70° C. for 2 hours, 45 parts by weight of ion-exchanged water and 4.5 parts by weight of the polymerization initiator were added, and the mixture was further heated at 70° C. for 3 hours. Isopropyl alcohol was distilled off under reduced pressure. After the mixture was allowed to cool, ion-exchanged water was added to provide a 30-wt % solution of the polymer 2.

### <Polymer 3>>

Alternating copolymer of diallyldimethylammonium and sulfur dioxide having the following repeating unit (“PAS-A-1” manufactured by Nittobo Medical Co., Ltd., weight-average molecular weight: 5,000).

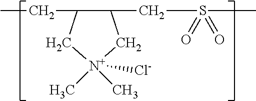

### <Polymer 4>

Random copolymer of vinylpyrrolidone and N,N-dimethylaminoethylmethacrylamide diethylsulfate having the following structure (“H.C. Polymer 2” manufactured by Osaka Organic Chemical Industry Ltd., weight-average molecular weight: about 80,000)

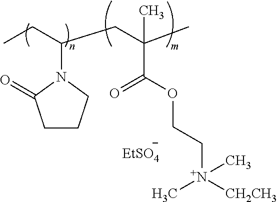

### [Evaluations]

### (Surface Treatment of Copper-Plated Plate)

A copper-plated plate having a size of 25 mm×25 mm was immersed in a 5% aqueous sulfuric acid solution for 60 seconds to be acid-washed, and then washed with water and dried to prepare a test piece. Surface treatment of copper was performed by immersing the test piece in the solution of Table 1 (25° C.) for 60 seconds. The test piece was removed from the solution, washed with water, and dried.

A stencil plate having a size of 10 mm×10 mm provided with 20 holes (4 columns×5 rows) having a diameter of 1 mm was placed on the in-plane center of the test piece after the surface treatment. At the positions of the holes of the stencil plate, 10 tin balls (“Sparkle ball S” manufactured by Senju Metal Industry Co., Ltd., Sn: 100%) having a diameter of 0.76 mm were alternately arranged and brought into contact with the treated test piece. The test piece on which the stencil plate and the 10 tin balls were placed was placed on a hot plate heated to 270° C. and the test piece was heated for 30 seconds, such that the tin balls were thermocompression-bonded to the surface of the test piece by the weight of the tin balls and the heating of the hot plate.

The heated sample was placed on a horizontal table, the stencil was removed from the test piece, and the tin balls were picked up one by one with tweezers. At that time, the tin ball with which the test piece (and the tin balls bonded thereon) was lifted together without falling off was judged to have acceptable joining performance, and the number of such tin balls was counted.

The above test was performed three times for one treatment solution, and the total number of the tin balls with which the copper-plated plates were lifted together without falling off was taken as the joining performance score. The maximum score was 30 points, and the larger the number, the higher the joining performance of the tin balls to the copper surface.

Table 1 shows the compositions and the results of evaluation of the solutions of examples and comparative examples.

TABLE 1

| | Combination | | | Joining |
|---|---|---|---|---|
| | Component | g/L | mM | performance |
| Example 1 | Copper acetate monohydrate | 1 | 5.01 | 28 |
| | Potassium thiocyanate | 0.2 | 2.06 | |
| | Lysine | 10 | 68.4 | |
| Example 2 | Copper sulfate pentahydrate | 2 | 8.01 | 23 |
| | 6-Methyl-2-thiouracil | 0.01 | 0.07 | |
| | Arginine | 5 | 37.8 | |
| Example 3 | Copper chloride dihydrate | 5 | 29.3 | 26 |
| | Thiourea dioxide | 0.02 | 0.18 | |
| | Histidine | 10 | 64.5 | |
| Example 4 | Copper nitrate trihydrate | 5 | 20.7 | 24 |
| | 6-Methyl-2-thiouracil | 0.1 | 0.70 | |
| | Aminoguanidine bicarbonate | 20 | 147 | |
| Example 5 | Copper sulfate pentahydrate | 10 | 40.1 | 22 |
| | Thiourea | 0.2 | 2.63 | |
| | Guanylurea sulfate | 1 | 3.31 | |
| Example 6 | Copper sulfate pentahydrate | 0.1 | 0.40 | 30 |
| | Potassium thiocyanate | 0.001 | 0.01 | |
| | Polymer 1 | 50 | — | |
| Example 7 | Copper chloride dihydrate | 0.05 | 0.29 | 30 |
| | Potassium thiocyanate | 0.3 | 3.09 | |
| | Polymer 2 | 5 | — | |
| Example 8 | Copper sulfate pentahydrate | 10 | 40.1 | 29 |
| | S-ethylisothiourea hydrobromide | 0.05 | 0.27 | |
| | Diallyldimethylammonium chloride | 50 | 309 | |
| Example 9 | Copper sulfate pentahydrate | 0.1 | 0.40 | 30 |
| | Potassium thiocyanate | 0.001 | 0.01 | |
| | Polymer 3 | 0.1 | — | |
| Example 10 | Copper sulfate pentahydrate | 0.1 | 0.40 | 30 |
| | S-ethylisothiourea hydrobromide | 0.1 | 0.54 | |
| | Polymer 4 | 0.1 | — | |
| Comparative | Copper sulfate pentahydrate | 25 | 100 | 2 |
| Example 1 | Thiourea | 0.2 | 2.63 | |
| | Guanylurea sulfate | 1 | 3.31 | |
| Comparative | Copper sulfate pentahydrate | 10 | 40.1 | 5 |
| Example 2 | Thiourea | 2 | 26.3 | |
| | Guanylurea sulfate | 1 | 3.31 | |
| Comparative | Copper nitrate trihydrate | 5 | 20.70 | 0 |
| Example 3 | Aminoguanidine bicarbonate | 20 | 147 | |
| Comparative | Copper sulfate pentahydrate | 0.1 | 0.40 | 0 |
| Example 4 | Thiosulfuric acid | 0.2 | 1.75 | |
| | Polymer 2 | 50 | — | |
| Comparative | Copper sulfate pentahydrate | 0.1 | 0.40 | 1 |
| Example 5 | Cysteamine | 0.2 | 2.59 | |
| | Polymer 2 | 50 | — | |
| Comparative | Potassium thiocyanate | 0.2 | 2.06 | 0 |
| Example 6 | Lysine | 10 | 68.4 | |
| Comparative | Aluminum acetate | 5 | 30.85 | 0 |
| Example 7 | 6-Methyl-2-thiouracil | 0.1 | 0.70 | |
| | Aminoguanidine bicarbonate | 20 | 147 | |
| Comparative | Copper sulfate pentahydrate | 2 | 8.01 | 6 |
| Example 8 | 6-Methyl-2-thiouracil | 0.01 | 0.07 | |

In Examples 1 to 10 in which the surface treatment was performed with a solution containing a basic amino acid, a guanidine compound, or a quaternary ammonium salt as the nitrogen-containing basic compound in addition to the water-soluble copper salt and the thio compound, the joining performance score was 20 or more, and tin balls were thermocompression-bonded to the copper surface after the treatment, and thus good joining performance was exhibited.

In Comparative Example 3 in which no thio compound was contained, the joining performance score was 0, and the joining performance of tin to the copper surface was extremely poor. The same applies to Comparative Example 4 using thiosulfuric acid, which is a thio compound not containing nitrogen. In Comparative Example 5 in which cysteamine, which is a thio compound in which a nitrogen atom and a sulfur atom are bonded to different carbon atoms, was used, the score was 1, and the joining performance of tin to the copper surface was poor as in Comparative Examples 3 and 4.

Comparative Example 6 in which the water-soluble copper salt was not contained, Comparative Example 4 in which the aluminum salt was contained but the water-soluble copper salt was not contained, and Comparative Example 7 in which the thio compound did not contain a nitrogen atom also achieved scores of 0, and the joining performance was extremely poor. In Comparative Example 8 in which no nitrogen-containing basic compound was contained, the score was 6, and the joining performance was better than in Comparative Examples 3 to 7, but was insufficient as compared with Examples 1 to 10.

From the above results, it is considered that the water-soluble copper salt and the thio compound having a structure in which nitrogen atom(s) and sulfur atom(s) are bonded to one carbon atom are essential for improving the joining performance to tin on the copper surface, and the inclusion of the nitrogen-containing basic compound promotes the surface treatment (film formation).

In Comparative Example 1 in which the concentration of the water-soluble copper salt was 100 mM and Comparative Example 2 in which the concentration of the thio compound was 26.3 mM, the scores were low, and the joining performance was insufficient. Comparison between Example 5 and Comparative Examples 1 and 2 shows that when the concentrations of the water-soluble copper salt and the thio compound are high, a sufficient joining performance improving effect cannot be obtained.

1. A surface treatment liquid for copper, the surface treatment liquid being an aqueous solution containing:
a water-soluble copper salt;
a thio compound having a structure containing one or more nitrogen atoms and one or more sulfur atoms covalently bonded to one carbon atom; and
one or more nitrogen-containing basic compounds selected from basic amino acids, guanidine compounds, and quaternary ammonium salts,
wherein a molar concentration of the water-soluble copper salt is 0.05 to 70 mM, and
a molar concentration of the thio compound is 0.005 to 20 mM.

2. The surface treatment liquid according to claim 1, wherein the molar concentration of the water-soluble copper salt is 0.05 to 500 times the molar concentration of the thio compound.

3. The surface treatment liquid according to claim 1, wherein the nitrogen-containing basic compound is a quaternary ammonium salt polymer having a molecular weight of 1,000 or more.

4. A copper surface treatment method comprising bringing the surface treatment liquid according to claim 1 into contact with a copper surface.

5. A copper-tin joining method comprising: surface-treating copper by the method according to claim 4; and thermocompression-bonding a tin member to the treated surface.

6. A copper-tin joined body production method comprising: subjecting copper to surface treatment by the method according to claim 4; and joining copper and tin by thermocompression-bonding a tin member to the treated surface.
